(19) United States
(12) Patent Application Publication
(10) Pub. No.: US 2012/0185118 A1
(43) Pub. Date: Jul. 19, 2012

(54) SYSTEM AND METHOD FOR OPTIMIZING A DRIVING ROUTE FOR A VEHICLE

(75) Inventor: Edward D. Tate, JR., Grand Blanc, MI (US)

(73) Assignee: GM GLOBAL TECHNOLOGY OPERATIONS LLC, Detroit, MI (US)

(21) Appl. No.: 13/009,141

(22) Filed: Jan. 19, 2011

(51) Int. Cl. G01C 21/36; G06F 7/00

(52) U.S. Cl. 701/22

(57) ABSTRACT

A vehicle includes a power source, an energy storage device, a navigation system, and a controller. The power source is configured to drive the vehicle. The energy storage device is configured to supply energy to the power source. The navigation system includes a memory location. The controller is configured for determining an optimized route for the vehicle driving on a plurality of roads and road segments, as a function of powertrain limitations of the vehicle. The optimized rout for the vehicle may be presented to the driver of the vehicle on a visual display screen.

### TECHNICAL FIELD

The present invention relates to a system and method for optimizing a driving route for a vehicle.

### BACKGROUND

Vehicles employ various power sources for propulsion. Such power sources may include an internal combustion engine and/or one or more electric motors or a fuel-cell.

Each power source typically requires an energy storage device configured to receive and store energy, and to supply the stored energy to operate the power source. A specific amount of energy stored within the energy storage device generally operates the vehicle for a finite driving range. Such a driving range typically depends on a number of factors which may be related to the vehicle itself, as well as to road and weather conditions. Additionally, a vehicle operator's driving style may also influence the vehicle's available driving range.

### SUMMARY

A method of optimizing a route for a vehicle driving on a plurality of roads includes recording information in a memory location relating to the plurality of roads, including: a geographical location of a plurality of road segments; topographical information pertaining to the plurality of road segments; and at least one intersection defined between one of the plurality of roads and at least two of the plurality of road segments. At least one of the plurality of road segments likely to be driven upon by the vehicle in the future is identified. Powertrain limitations of the vehicle are determined and at least one of the plurality of road segments likely to be driven upon by the vehicle in the future are modeled with the determined powertrain limitations of the vehicle to predict if the vehicle can drive upon the at least one of the plurality of road segments likely to be driven upon by the vehicle without a substantial degradation of vehicle operating performance. At least one of the plurality of road segments likely to be driven upon by the vehicle that has been determined to not result in a substantial degradation of vehicle operating performance is identified. The intersection defined between the identified at least one of the plurality of road segments likely to be driven upon by the vehicle that has been determined to not result in a substantial degradation of vehicle operating performance and the one of the plurality of roads the vehicle is currently being driven upon is identified. The driver of the vehicle is alerted as to the location of an intersection where the vehicle may enter the at least one of the plurality of road segments likely to be driven upon by the vehicle that has been determined to not result in a substantial degradation of vehicle operating performance.

A vehicle includes a power source, an energy storage device, and a navigation system. The power source is configured to drive the vehicle. The energy storage device is configured to supply energy to the power source. The navigation system includes a memory location and a controller. The controller is configured for recording information in the memory location relating to a plurality of roads, including: a geographical location of a plurality of road segments, topographical information pertaining to the plurality of road segments, and at least one intersection defined between one of the plurality of roads and at least two of the plurality of road segments. The controller is also configured for geographically locating the vehicle on the one of the plurality of roads; identifying at least one of the plurality of road segments that are likely to be driven upon by the vehicle in the future; and determining a state of charge (SOC) of the energy storage device to assess powertrain limitations of the vehicle. Additionally, the controller is configured for modeling the at least one of the plurality of road segments likely to be driven upon by the vehicle in the future and the determined powertrain limitations of the vehicle to predict if the vehicle can drive upon the at least one of the plurality of road segments likely to be driven upon by the vehicle without a substantial degradation of vehicle operating performance. The controller is also configured to identify at least one of the plurality of road segments likely to be driven upon by the vehicle that has been determined to not result in a substantial degradation of vehicle operating performance and to locate the intersection defined between the identified at least one of the plurality of road segments likely to be driven upon by the vehicle that has been determined to not result in a substantial degradation of vehicle operating performance and the one of the plurality of roads the vehicle is currently being driven upon. Additionally, the controller is configured to alert a driver of the vehicle of the location of an intersection where the vehicle may enter the at least one of the plurality of road segments likely to be driven upon by the vehicle that has been determined to not result in a substantial degradation of vehicle operating performance.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic plan view of a vehicle having a navigation system configured for providing an optimized driving route to a driver;

FIG. 2 is an illustration of a visual display configured for communicating the optimized driving route to the driver of the vehicle;

FIG. 3 is an illustration of another visual display of the visual display configured for communicating the optimized driving route to the driver of the vehicle; and

FIG. 4 is a flow chart illustrating a method for optimizing a driving route for the vehicle.

### DETAILED DESCRIPTION

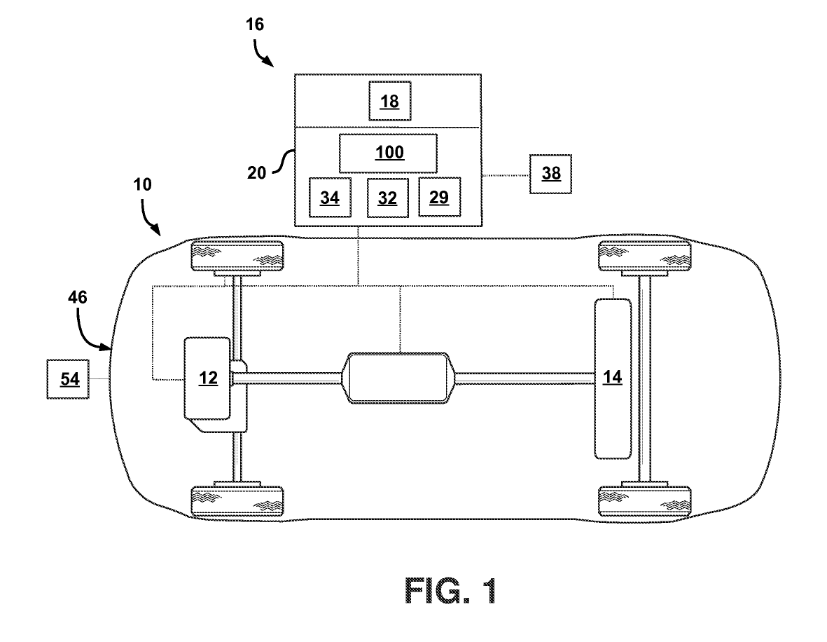

Referring to the drawings, wherein like reference numbers correspond to like or similar components throughout the several figures, FIG. 1 shows a vehicle 10 that includes a power source 12, an energy storage device 14, and a navigation system 16. The power source 12 is configured to drive or otherwise propel the vehicle 10. The energy storage device 14 is configured to supply energy to the power source 12. The energy storage device 14 may be a battery, a fuel tank, and the like.

The vehicle 10 may be an internal combustion vehicle or an electric vehicle (EV), such as a battery electric vehicle (BEV), a fuel cell vehicle, a hybrid electric vehicle (HEV), and the like. The performance of certain vehicles may have limitations. The limitations may, for example, be a result of a state of charge (SOC) of the energy storage device 14 being insufficient for the power source 12 to generate enough power to propel or drive the vehicle 10 up roads 22 having high grades. The performance may also be limited by a cargo load of the vehicle 10. The limited performance may affect the operation of the vehicle 10 on some extreme roads 22, e.g., roads with high grades. For example, driving the vehicle 10 on certain extreme roads 22 may cause the vehicle 10 to drive much slower than a posted speed limit and/or stop all together. Choosing alternative roads that are not extreme may minimize the impact of these limitations on performance of the vehicle 10, which may prevent a driver of the vehicle 10 from becoming stuck and/or humiliated on the extreme road 22.

The navigation system 16 is configured to determine and/or provide an optimized driving route to a driver of the vehicle 10. The navigation system 16 may include or otherwise be operatively connected to a memory location 18 and a controller 20. In one embodiment, the memory location 18 may be disposed remotely from the navigation system 16 such that the navigation system 16 is configured to access the memory location 18 remotely, i.e., wired, wirelessly, and the like. Information relating to a plurality of roads 22, including maps 24, a geographical location of a plurality of road segments 26, topographical information pertaining to the plurality of road segments 26, at least one intersection 28, 30, and posted speed limit is recorded in the memory location 18. The topographical information includes road grades that the vehicle 10 would need to ascend in order to traverse the roads 22 and/or road segments 26.

The controller 20 includes an algorithm 100 that provides a method of determining the optimized driving route for the vehicle 10, as explained in more detail below. The controller 20 may be configured as a digital computer generally comprising a microprocessor or central processing unit (CPU), at least one memory device, a high-speed clock, analog-to-digital (A/D) and digital-to-analog (D/A) circuitry, and input/output circuitry and devices (I/O), as well as appropriate signal conditioning and buffer circuitry. The memory device may include read only memory (ROM), random access memory (RAM), electrically-erasable programmable read only memory (EEPROM), and the like. It should be appreciated that more than one algorithm may also be included in the controller 20. The algorithms 100 resident in the controller 20, or accessible thereby, including the algorithm 100, as described below with reference to FIG. 1, can be stored and executed to provide the respective functionality. The algorithm is configured to automatically sample and archive a predetermined set of vehicle statistical information, e.g., energy consumption and distance traveled, along with any other additional vehicle 10 and/or environmental information. The sampling and arching may be continuous or at predefined time intervals, as known to those of skill in the art.

In general, computing systems and/or devices, such as the CPU, may employ any of a number of computer operating systems and generally include computer-executable instructions, where the instructions may be executable by one or more computing devices such as those listed above. Computer-executable instructions may be compiled or interpreted from computer programs created using a variety of well known programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

The navigation system 16 may optionally include a telematics unit 32 and/or a visual display screen 34. More specifically, in one embodiment, the controller 20 may communicate the statistical information to the telematics unit 32. The telematics unit 32 may use, by way of a non-limiting example, Bluetooth®, OnStar®, cell phone, or other suitable system, and the like. The telematics unit 32 may be configured to monitor, record, and transmit the statistical information pertaining to operation of vehicle 10 by the driver. The telematics unit 32 may also be configured to monitor internal communication, such as bus traffic between various distributed control modules of the controller 20 when the controller 20 is so configured. The statistical information may be transmitted from the memory location 18 to a remote station, or be recorded and retained within the memory location 18 for later access and processing. As described below, the vehicle 10 may be equipped with the visual display screen 34 that is adapted for displaying messages in the form of maps 24, text messages, e-mail, Hypertext Transfer Protocol (HTTP) links, and the like. The electric vehicle 10 may also be equipped with speakers 29 that are configured for providing audio messages and alerts to the driver of the vehicle 10.

Still referring to FIG. 1, the memory location 18 may include the RAM and ROM. The ROM may include the basic operating system of the navigation system 16, and/or any other required data, communications protocols, and operating parameters which generally require permanent storage and rapid accessibility. The function of the RAM may include the manipulation and storage of vehicle performance values and other operating data of the vehicle 10, as set forth below. The navigation system 16 may also include a power supply circuit, a global positioning system (GPS) circuit, and an input/output (I/O) interface, as understood in the art.

Still referring to FIG. 1, the system may include one or more sensors 38 that are configured to collect vehicle 10 performance values and data describing a driver's unique driving behavior. Data from sensors 38 may include, but is not limited to, information describing vehicle 10 speed history, Heating, Ventilation, and Air Conditioning (HVAC) usage history, location history of the vehicle 10, dates, times of day during which the vehicle 10 is operated, odometer readings, cargo load, and the like. Data from the sensors 38 is used by the controller 20 to automatically calculate the ranges related to the SOC or energy capacity of the energy storage device 14. For example, controller 20 may generate or compile statistical information for transmission to the remote station, and/or for onboard storage and archiving in the memory location 18.

The statistical information is specific to the vehicle 10 and/or any driver(s) thereof over a period of time, and could also include, without being limited to: average fuel consumption or average vehicle speed over a specified time period; a cumulative density function chart describing the percentage of driving where less than a predetermined amount of fuel consumption was achieved over the specified time period; a probability density function chart showing a distribution of fuel consumption over the specified time period; a cumulative density function chart showing a percentage of driving where greater than a threshold distance was achieved over the specified time period; a probability density function chart showing distribution of driving distances over the specified time period; and city driving fuel consumption, which is defined as the average fuel consumption for all driving over a specified time period where the average vehicle speed over a given key operating cycle is below a specified vehicle speed.

The statistical information may further include: highway driving fuel consumption defined as the average fuel consumption for all driving over a specified time period where the average vehicle speed over a given key cycle was above a specified speed; city driving fuel consumption divided by vehicle label city fuel consumption; highway driver intensity factor defined as highway driving fuel consumption divided by the vehicle label city fuel consumption; composite driver intensity factor defined as average fuel consumption divided by the vehicle label composite fuel consumption; local electric utility rates; the current and/or projected average price of gasoline; etc.

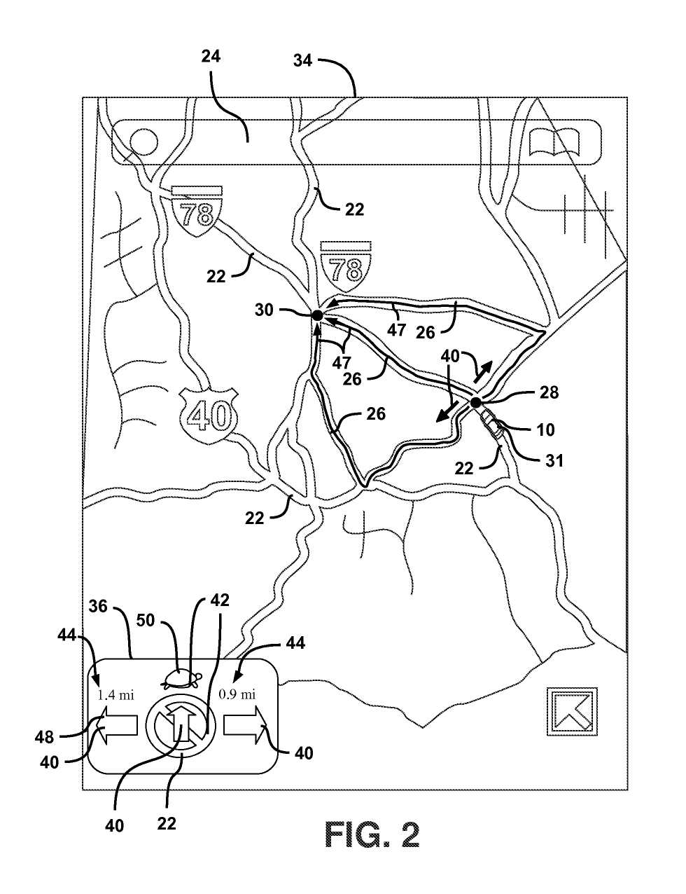

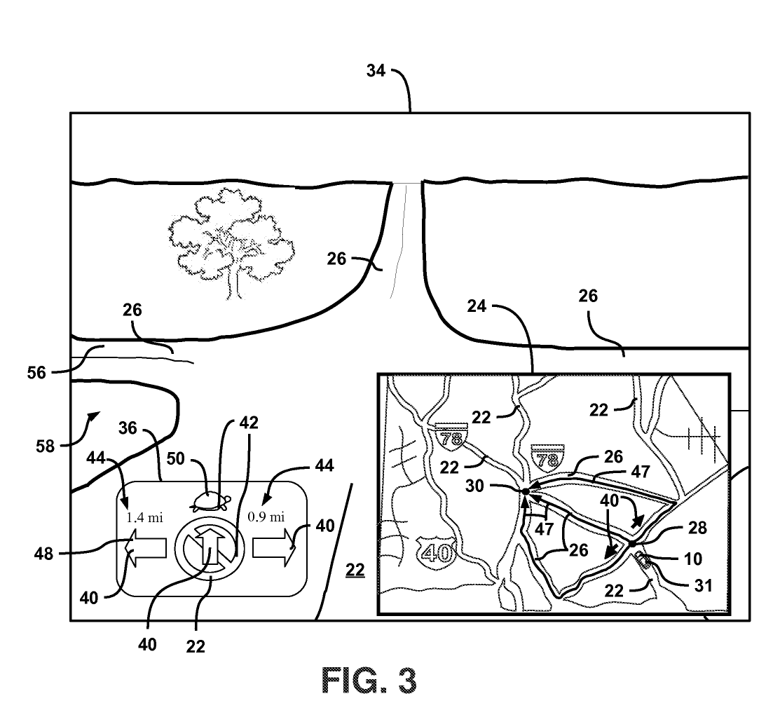

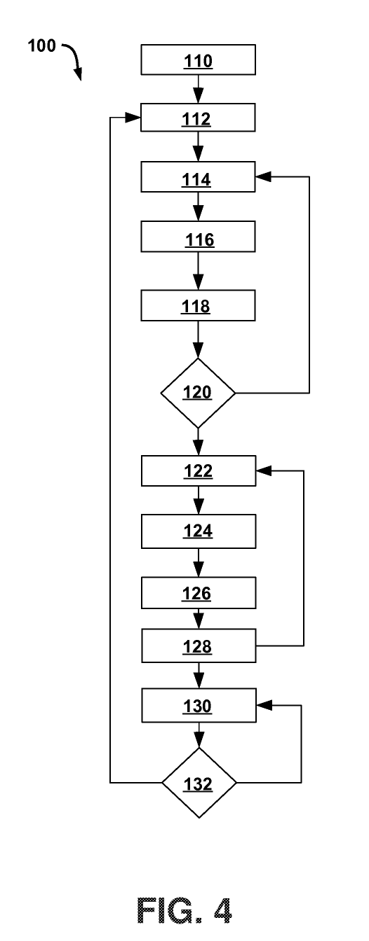

Referring to FIG. 4, and with reference to FIGS. 1-3, the algorithm 100 may be executed by the controller 20 and includes steps 112-132. At step 110, information relating to the roads 22 is stored in the memory location 18. The information includes the geographical locations of a plurality of the roads 22 and the road segments 26, and the topographical information pertaining to the plurality of roads 22 and road segments 26. The information also includes at least one intersection 28, 30, i.e., “decision points”, that is defined between at least two of the road segments 26 and at least one of the roads 22. The road segments 26 are defined between a pair of intersections 28, 30, as illustrated in FIGS. 2 and 3. The road segments 26 are portions of the road 22 that extend from, and back to, the road 22, i.e., a detour, or lead from the road 22 to a different road 22. Therefore, the intersections 28, 30 are junctions between of one or more of the roads 22 where the roads 22 split into one or more road segments 26, giving the driver of the vehicle 10 the option of making a decision to either stay on the road segment 26 corresponding to the road 22 currently being traveled upon to leave the road 22 currently being traveled upon and change to another road segment 26. The intersections 28, 30 may include a first intersection 28 and a second intersection 30. The first intersection 28 is defined between the road segments 26 likely to be driven upon by the vehicle 10 and the road 22 currently being traveled upon by the vehicle 10. The second intersection 30 is defined between the road segments 26 likely to be driven upon by the vehicle 10 and at least one road 22 the vehicle 10 is likely to travel upon in the future, i.e., after the vehicle traverses or otherwise departs from one of the plurality of road segments 26. Accordingly, the road segments 26 extend between the first intersection 28 and the second intersection 30.

The vehicle 10 is driven on one of the roads 22, as shown in FIGS. 2 and 3, at step 110. At step 112, the vehicle 10 is geographically located on the road 22. The geographical location may be the geographical coordinates of the vehicle 10, i.e., latitude and longitude. The geographical location may be determined using a location system, such as, a GPS system, a cell location system, a radio location system, and/or any other location system, as known to those of skill in the art. Referring to FIGS. 2 and 3, an icon 31 representing the vehicle 10 is displayed on the map 24 to represent the location of the vehicle 10 with respect to the roads 22.

At step 114, at least one of the road segments 26 that is to be driven upon by the vehicle 10 in the future is identified. More specifically, based on the identified geographical location of the vehicle 10, a determination is made as to upcoming road segments 26 of the road 22 to be driven upon by the vehicle 10 or road segments 26 that intersect with the road 22 being driven upon by the vehicle 10 at the first intersection 28, as illustrated in FIGS. 2 and 3. Additionally, at least one of the roads 22 likely to be driven upon by the vehicle 10 after the vehicle 10 drives on at least one of the road segments 26 may also be identified.

The powertrain limitations of the vehicle 10 are determined at step 116. The powertrain limitations may include, but are not limited to, energy capacity of the energy storage device 14, e.g., SOC, the cargo load within the vehicle 10, outside temperature, weather conditions, altitude, posted speed limit, the grade of the road 22 and/or road segments 26, and the like. The powertrain limitations are those operating variables that may have an effect on the energy output of the power source 12.

At step 118, each of the road segments 26 likely to be driven upon by the vehicle 10 in the future are modeled, along with the determined powertrain limitations of the vehicle 10, in order to predict if the vehicle 10 can drive upon at least one of the road segments 26 without a substantial degradation of vehicle 10 operating performance.

At step 120, a determination is made as to whether the vehicle 10 can operate at a vehicle speed that is at least substantially equal to the posted speed limit, based on the determined powertrain limitations. If it is determined that the vehicle 10 can operate at a vehicle speed that is at least substantially equal to the posted speed limit, based on the determined powertrain limitations, step 114 is initiated. By way of a non-limiting example, if the SOC of the vehicle 10 and the road grade are such that the vehicle 10 can operate at a maximum speed of 60 mph, the determined powertrain limitations may be considered to not result in a substantial degradation of vehicle 10 operating performance. Alternatively, if it is determined that the vehicle 10 cannot operate at a vehicle speed, i.e., operation would result in substantial degradation of vehicle 10 operating performance, then step 122 is initiated. By way of a non-limiting example, if the SOC of the vehicle 10 and the road grade are such that the vehicle 10 can only operate at a maximum speed of 30 miles per hour (mph), while the posted speed limit is 55 mph, the determined powertrain limitations may be considered to provide a substantial degradation of vehicle 10 operating performance. In step 122, an identification is made as to the first intersection(s) 28 where the vehicle 10 may enter one of the road segments 26 to avoid a substantial degradation of vehicle 10 operating performance.

At step 124, an identification is made as to the second intersection(s) 30 where the vehicle 10 may leave the road segments 26.

At step 126, a route along at least one of the road segments 26 that has been determined to not result in a substantial degradation in vehicle 10 operating performance is generated. At step 128, a determination is made as to whether all of the routes along at least one of the road segments 26 that have been determined to not result in a substantial degradation of vehicle 10 operating performance have been generated. If it is determined that all possible routes have not been generated, then step 122 is initiated. If, however, it is determined that all possible routes have been generated, step 130 is initiated.

At step 130, the driver of the vehicle 10 is alerted as to the route(s) generated along at least one of the road segments 26. More specifically, the location of the first intersection 28 where the vehicle 10 may enter at least one of the road segments 26 likely to be driven upon by the vehicle 10, and that has been determined to not result in a substantial degradation of vehicle operating performance is displayed to the driver of the vehicle 10, i.e., on the visual display screen 34. Where possible, the driver is alerted to the location of the first intersection(s) 28 where the vehicle may enter at least two different road segments 26 likely to be driven upon by the vehicle 10, and that have each been determined to not result in a substantial degradation of vehicle operating performance Alerting a driver means that the location of the first intersection 28 is displayed on the visual display screen 34.

Referring specifically to FIGS. 2 and 3, the visual display screen 34 presents a map 24 that includes the roads 22, including the road segments 26 and the first intersection 28 defined between the roads 22 and the road segments 26, and the location of the vehicle 10 relative to the roads 22 and road segments 26. The routes and the corresponding road segments 26 may be highlighted, as indicated at 47, on the map 24 on the visual display screen 34. At least one of the road segments 26 highlighted 47 on the map 24 may be a road segment 26 that is likely to be driven upon by the vehicle 10 and that has been determined to not result in a substantial degradation of the vehicle 10 operating performance. Additionally, the driver of the vehicle 10 may be alerted as to the location of the second intersection 30 in order to better understand where the road segments 26 will terminate. This may assist the driver in determining whether the proposed route and corresponding road segment(s) 26 would take the driver toward their intended destination, or would take the driver too far away from their intended destination. It should be appreciated however, that an audio message pertaining to the information pertaining to the location of the first and/or second intersections 28, 30 may be transmitted through the speakers 29. The audio message may be in lieu of the visual display screen 34 or a supplement to the visual display screen 34 so as to limit any unnecessary distraction to the driver.

Additionally, alerting the driver at step 130 may also include displaying an indicator 36 in the visual display screen 34 that displays a choice between road segments 26. Referring again to FIGS. 2 and 3, the displayed feedback to the driver may include displaying at least one directional icon 40 on the visual display screen 34 that indicates a direction of travel of the vehicle 10 if the respective road segment 26 were chosen, i.e., left turn, right turn, straight ahead. A distance 44 between the first and second intersections 28, 30 that are associated with each road segment 26 may also be displayed on the visual display screen 34. The distance 44 may be displayed proximate the respective directional icon 40. It should also be appreciated that an audio message pertaining to one or more of the choice between the road segments 26 and the distance 44 between the first and second intersections 28, 30 associated with each road segment 26 may be transmitted through the speakers 29. The audio message may be in lieu of the visual display screen 34 or a supplement to the visual display screen 34 so as to limit any unnecessary distraction to the driver.

Also, the driver may be alerted at step 130 as to one or more road segments 26 that would result in a substantial degradation of vehicle 10 operating performance. Accordingly, a directional icon 40 may be displayed on the visual display screen 34 that indicates a direction of travel of the vehicle 10 for the respective road segment 26 that would result in a substantial degradation of vehicle 10 operating performance on the display screen. For instance, the directional icon 40 may be an arrow 48 that indicates a direction for the vehicle 10 to turn to reach the respective road segment 26, along with the distance to travel between the first and second intersections 28, 30. To further alert the driver that driving on a particular road segment 26 is a bad choice that would result in a substantial degradation of vehicle performance, at least one choice feedback icon 42 may be displayed on the visual display screen 34. The choice feedback icon 42 may be a turtle 50, a prohibition symbol 52, and the like. The prohibition symbol 52 may be displayed to overlay the respective directional icon 40 to communicate to the driver of the vehicle 10 that the road segment 26 associated with the directional arrow 48 would result in a substantial degradation of vehicle 10 operating performance. To further communicate to the driver that the road segment 26 is not a good choice, i.e., would result in a slowed vehicle speed and/or slowed acceleration rate, the turtle 50 may also be displayed in association with the directional arrow. It should be appreciated that other indicators 36 may also be used to communicate to the driver that a particular road segment 26 would result in a substantial degradation of vehicle 10 operating performance. Additionally, an audio message pertaining to the road segments 26 that would result in a substantial degradation of vehicle operating performance may be transmitted through the speakers 29. The audio message may be in lieu of the visual display screen 34 or a supplement to the visual display screen 34 so as to limit any unnecessary distraction to the driver.

Referring to FIGS. 1 and 3, the vehicle 10 may include a camera 54 operatively attached to the vehicle 10, e.g., at a front 46 of the vehicle 10. The camera 54 may be configured to capture an image 56 of a forward view 58 from the vehicle 10, including the road 22 that the vehicle 10 is currently driving upon. When the image 56 is captured by the camera 54, FIG. 3 illustrates the visual display screen 34 presenting the image 56 of the forward view 58 from the front 46 of the vehicle 10, along with the map 24.

At step 132, a determination is made as to whether the vehicle 10 is still on one of the road segments 26 that have been determined to not result in a substantial degradation of vehicle 10 operating performance. If the vehicle 10 is determined to still be on such a road segment 26, steps 128 and 130 are repeated until a determination is made that the vehicle is no longer on such a road segment 26, at which time step 112 is initiated.

While the best modes for carrying out the invention have been described in detail, those familiar with the art to which this invention relates will recognize various alternative designs and embodiments for practicing the invention within the scope of the appended claims.

1. A method of optimizing a route for a vehicle driving on a plurality of roads, the method comprising:
recording information in a memory location relating to the plurality of roads, including: a geographical location of a plurality of road segments, topographical information pertaining to the plurality of road segments, and at least one intersection defined between one of the plurality of roads and at least two of the plurality of road segments;
geographically locating the vehicle on the one of the plurality of roads;
identifying at least one of the plurality of road segments likely to be driven upon by the vehicle in the future;
determining powertrain limitations of the vehicle;
modeling the at least one of the plurality of road segments likely to be driven upon by the vehicle in the future and the determined powertrain limitations of the vehicle to predict if the vehicle can drive upon the at least one of the plurality of road segments likely to be driven upon by the vehicle without a substantial degradation of vehicle operating performance;
identifying at least one of the plurality of road segments likely to be driven upon by the vehicle that has been determined to not result in a substantial degradation of vehicle operating performance;
locating a first intersection and a second intersection;
wherein the first intersection is defined between the identified at least one of the plurality of road segments likely to be driven upon by the vehicle that has been determined to not result in a substantial degradation of vehicle operating performance and the one of the plurality of roads the vehicle is currently being driven upon;
wherein the second intersection is defined between the identified at least one of the plurality of road segments likely to be driven upon by the vehicle that has been determined to not result in a substantial degradation of vehicle performance and the identified at least one of the plurality of roads likely to be driven upon by the vehicle such that the at least one of the plurality of road segments extends between the first and second intersection; and
alerting a driver of the vehicle of the location of the intersection where the vehicle may enter the at least one of the plurality of road segments likely to be driven upon by the vehicle that has been determined to not result in a substantial degradation of vehicle operating performance.

2. A method, as set forth in claim 1, wherein alerting a driver is further defined as displaying the location of the intersection where the vehicle may enter the at least one of the plurality of road segments likely to be driven upon by the vehicle that has been determined to not result in a substantial degradation of vehicle operating performance on a visual display screen.

3. A method, as set forth in claim 2, wherein the visual display screen presents a map including: the plurality of roads, the plurality of road segments, the at least one intersection defined between one of the plurality of roads and at least two road segments, and the location of the vehicle relative to the roads and road segments.

4. A method, as set forth in claim 3, wherein alerting the driver is further defined as highlighting the at least one of the plurality of road segments likely to be driven upon by the vehicle that has been determined to not result in a substantial degradation of vehicle operating performance on the map on the visual display screen.

5. A method, as set forth in claim 3, further comprising capturing an image of a forward view from a front of the vehicle with a camera, the image including the one of the plurality of roads that the vehicle is operating upon; and
wherein the visual display screen presents the image of the forward view from the front of the vehicle and the map.

6. A method, as set forth in claim 2, wherein alerting the driver is further defined as displaying feedback to the driver on visual display screen that includes at least one road segment that would not result in a substantial degradation of vehicle operating performance.

7. A method, as set forth in claim 6, wherein displaying feedback to the driver on the display screen that includes at least one road segment that would not result in a substantial degradation of vehicle operating performance is further defined as displaying at least one directional icon on the visual display screen that indicates a direction of travel of the vehicle for the at least one road segment that would not result in a substantial degradation of vehicle operating performance.

8. A method, as set forth in claim 7, further comprising displaying on the visual display screen a distance associated with the at least one road segment that would not result in a substantial degradation of vehicle operating performance.

9. A method, as set forth in claim 2, wherein alerting the driver is further defined as displaying feedback to the driver on the visual display screen that includes at least one road segment that would result in a substantial degradation of vehicle performance.

10. A method, as set forth in claim 9, wherein displaying feedback to the driver on the display screen that includes at least one road segment that would result in a substantial degradation of vehicle operating performance is further defined as displaying at least one directional icon on the visual display screen that indicates a direction of travel of the vehicle for the at least one road segment that would result in a substantial degradation of vehicle operating performance.

11. A method, as set forth in claim 9, wherein displaying feedback to the driver on the visual display screen that includes at least one road segment that would result in a substantial degradation of vehicle operating performance is further defined as displaying at least one choice feedback icon on the visual display screen that indicates that the at least one road segment that would result in a substantial degradation of vehicle operating performance is a bad choice.

12. (canceled)

13. A method, as set forth in claim 1, further comprising transmitting an audio message pertaining to the location of the intersection where the vehicle may enter the at least one of the plurality of road segments likely to be driven upon by the vehicle that has been determined to not result in a substantial degradation of vehicle operating performance through a speaker.

14. A vehicle comprising:
a power source configured to drive the vehicle;
an energy storage device configured to supply energy to the power source; and
a navigation system having a memory location and a controller;
wherein the controller is configured for:
recording information in the memory location relating to a plurality of roads, including: a geographical location of a plurality of road segments, topographical information pertaining to the plurality of road segments, and at least one intersection defined between one of the plurality of roads and at least two of the plurality of road segments;
geographically locating the vehicle on the one of the plurality of roads;
identifying at least one of the plurality of road segments likely to be driven upon by the vehicle in the future;
determining a state of charge (SOC) of the energy storage device to assess powertrain limitations of the vehicle;
modeling the at least one of the plurality of road segments likely to be driven upon by the vehicle in the future and the determined powertrain limitations of the vehicle to predict if the vehicle can drive upon the at least one of the plurality of road segments likely to be driven upon by the vehicle without a substantial degradation of vehicle operating performance;
identifying at least one of the plurality of road segments likely to be driven upon by the vehicle that has been determined to not result in a substantial degradation of vehicle operating performance;
locating a first intersection and a second intersection;
wherein the first intersection is defined between the identified at least one of the plurality of road segments likely to be driven upon by the vehicle that has been determined to not result in a substantial degradation of vehicle operating performance and the one of the plurality of roads the vehicle is currently being driven upon;
wherein the second intersection is defined between the identified at least one of the plurality of road segments likely to be driven upon by the vehicle that has been determined to not result in a substantial degradation of vehicle performance and the identified at least one of the plurality of roads likely to be driven upon by the vehicle such that the at least one of the plurality of road segments extends between the first and second intersection; and
alerting a driver of the vehicle of the location of the intersection where the vehicle may enter the at least one of the plurality of road segments likely to be driven upon by the vehicle that has been determined to not result in a substantial degradation of vehicle operating performance.

15. A vehicle, as set forth in claim 14, wherein the navigation system includes a visual display screen configured for displaying the location of the intersection where the vehicle may enter the at least one of the plurality of road segments likely to be driven upon by the vehicle that has been determined to not result in a substantial degradation of vehicle operating performance.

16. A vehicle, as set forth in claim 15, wherein the visual display screen is configured to present a map including: the plurality of roads, the plurality of road segments, the at least one intersection defined between one of the plurality of roads and at least two road segments, and the location of the vehicle relative to the roads and road segments.

17. A method, as set forth in claim 15, wherein the visual display screen is configured to display highlighting of the at least one of the plurality of road segments likely to be driven upon by the vehicle that has been determined to not result in a substantial degradation of vehicle operating performance on the map on the visual display screen.

18. A vehicle, as set forth in claim 15, further comprising a camera configured to capture an image of a forward view from a front of the vehicle;
wherein the image includes the one of the plurality of roads that the vehicle is operating upon; and
wherein the visual display screen is configured to present the image of the forward view from the front of the vehicle and the map.

19. A vehicle, as set forth in claim 15, further comprising a speaker configured to transmit an audio message pertaining to the location of the intersection where the vehicle may enter the at least one of the plurality of road segments likely to be driven upon by the vehicle that has been determined to not result in a substantial degradation of vehicle operating performance.

20. A navigation system configured to optimize a driving route for a vehicle driving on roads, the navigation system comprising:
a visual display screen;
a memory location; and
a controller configured for:
recording information in the memory location relating to a plurality of roads, including: a geographical location of a plurality of road segments, topographical information pertaining to the plurality of road segments, and at least one intersection defined between one of the plurality of roads and at least two of the plurality of road segments;
geographically locating the vehicle on the one of the plurality of roads;
identifying at least one of the plurality of road segments likely to be driven upon by the vehicle in the future;
determining powertrain limitations of the vehicle;
modeling the at least one of the plurality of road segments likely to be driven upon by the vehicle in the future and the determined powertrain limitations of the vehicle to predict if the vehicle can drive upon the at least one of the plurality of road segments likely to be driven upon by the vehicle without a substantial degradation of vehicle operating performance;
identifying at least one of the plurality of road segments likely to be driven upon by the vehicle that has been determined to not result in a substantial degradation of vehicle operating performance;
locating a first intersection and a second intersection;
wherein the first intersection is defined between the identified at least one of the plurality of road segments likely to be driven upon by the vehicle that has been determined to not result in a substantial degradation of vehicle operating performance and the one of the plurality of roads the vehicle is currently being driven upon;
wherein the second intersection is defined between the identified at least one of the plurality of road segments likely to be driven upon by the vehicle that has been determined to not result in a substantial degradation of vehicle performance and the identified at least one of the plurality of roads likely to be driven upon by the vehicle such that the at least one of the plurality of road segments extends between the first and second intersection; and
alerting a driver of the vehicle on the visual display screen of the location of the intersection where the vehicle may enter the at least one of the plurality of road segments likely to be driven upon by the vehicle that has been determined to not result in a substantial degradation of vehicle operating performance.
